(19) United States
(12) Patent Application Publication
(10) Pub. No.: US 2021/0040992 A1
(43) Pub. Date: Feb. 11, 2021

(54) SEALING DEVICE

(71) Applicant: Aktiebolaget SKF, Goteborg (SE)

(72) Inventors: Giorgio Barberis, Volpiano (TO) (IT); Giorgia D'Amico, Torino (IT); Fabio Nosenzo, Asti AT (IT)

(21) Appl. No.: 16/875,998

(22) Filed: May 16, 2020

(30) Foreign Application Priority Data
Aug. 5, 2019 (IT) 102019000013908

(51) Int. Cl. F16C 33/80; F16C 19/08

(52) U.S. Cl. CPC F16C 33/805; F16C 19/08

(57) ABSTRACT

A sealing device for a bearing unit is provided. The sealing device includes a dynamic component, a static component having a shaped metallic support, and a plurality of sealing lips not making contact with the dynamic component and two lips making contact with the dynamic component. A second sealing lip of the non-contacting sealing lips and the dynamic component define a labyrinth seal, and a fixed spoiler arranged along the labyrinth seal for the creation of turbulent motion inside the labyrinth seal to provide a complete sealing action preventing any entry of components inside the bearing unit.

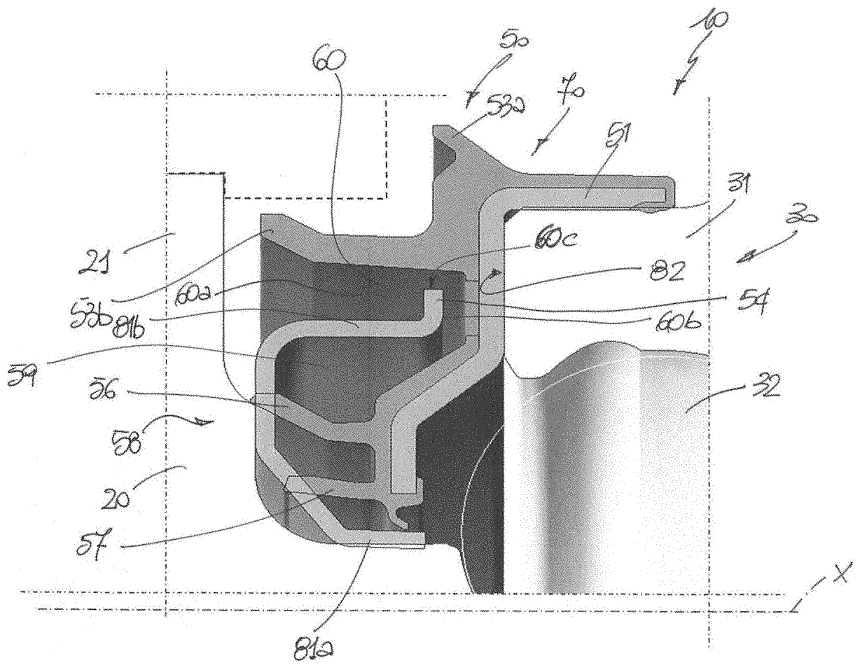

### CROSS-REFERENCE TO RELATED APPLICATIONS

This application claims priority to Italian Patent Application no. 102019000013908, filed Aug. 5, 2019, the contents of which is fully incorporated herein by reference.

### FIELD OF THE INVENTION

The present invention relates to a sealing device with innovative features which provide it with an improved sealing action against contaminants. Such a sealing device is applied to a bearing unit. The present invention is suitable in particular, although not exclusively, for the wheel hub assemblies of motor vehicles, the assemblies being provided with a bearing unit. More particularly, the bearing units according to the invention are those in which the outer ring of the bearing is stationary, while the inner ring of the bearing is rotatable. This invention is applicable, advantageously but not exclusively, to a bearing unit having a double row of balls.

### BACKGROUND OF THE INVENTION

As is known, bearing units are generally exposed to contaminants of different types, for example, mud, dust and suspended particulate matter and/or particles in a solution and, therefore, the bearing units, including those forming part of wheel hub assemblies for motor vehicles, must be provided with sealing devices which protect them from attack by the aforementioned contaminants. Sealing devices according to the prior art consist, for example, of two-part cassette sealing devices, comprising a rotating portion, mounted on the radially inner ring, and a stationary portion, mounted on the radially outer ring. According to the prior art, the stationary portion of the seal comprises one or more lips made of elastomeric material making contact with the rotating portion and ensuring a sealing action with respect to the inside of the bearing unit.

Both during on-road operating conditions and during the operations for validation of a bearing unit, in order to optimize the sealing performance of the bearing unit and at the same time ensure low friction levels, it is known to use sealing devices provided with a screen for protecting an aperture of the bearing unit and with a non-contacting sealing lip directed towards the screen, in order to prevent as far as possible mud and other contaminants from penetrating beyond the sealing device inside the bearing unit. In particularly critical operating conditions, however, it has been seen how the sealing devices according to the prior art have drawbacks, such as a limited sealing capacity, and, in order to overcome these drawbacks, a known solution has always been that of increasing the number of sealing lips in order to make it more difficult for any contaminants to enter. This solution, however, while solving the aforementioned drawback, makes the manufacture of the sealing device particularly problematic in terms of both design and production costs and also results in an increase in the friction torque with negative effects on the performance of the bearing unit.

### SUMMARY OF THE INVENTION

The object of the present invention is to provide a sealing device which, while maintaining a relatively simple design and structure, is able to ensure an optimum sealing action also in the case of particularly critical conditions of use.

According to the present invention a sealing device having the characteristic features indicated in the attached claims is provided.

Further preferred and/or particularly advantageous embodiments of the invention are described in accordance with the characteristic features indicated in the attached dependent claims.

### BRIEF DESCRIPTION OF THE DRAWINGS

The invention will now be described with reference to the attached FIGURE which shows a cross-section of a non-limiting example of embodiment of a sealing device according to the present invention.

### DETAILED DESCRIPTION OF THE INVENTION

With reference to the attached FIGURE, a wheel hub assembly according to a preferred embodiment of the invention is denoted overall by 10. The FIGURE shows a detail of the configuration provided by way of example.

The assembly 10 has a central axis of rotation X and comprises a rotating and flanged hub 20, namely a hub provided with a flange 21 transverse to the axis X, and a bearing unit 30 in turn comprising:

a stationary radially outer ring 31;

a radially inner ring 20 defined by the hub 20; and

two rows of rolling bodies 32 (only one of which is shown), in this example balls, arranged between the radially outer ring 31 and the radially inner ring 20.

In the whole of the present description and the claims, the terms and expressions indicating positions and orientations such as “radial” and “axial” are understood as referring to the central axis of rotation X of the bearing unit 30. Expressions such as “axially outer” and “axially inner” refer instead to the assembled condition of the wheel hub assembly and, in the specific case, preferably refer to a wheel side and, respectively, to a side opposite to the wheel side.

The wheel hub assembly 10 is provided with a sealing device 50, preferably, but not necessarily, a two-part cassette sealing device, which is mounted on the axially outer side of the bearing unit 30 between the flange 21 and the radially outer ring 31 and comprises a static component 70 mounted on the radially outer ring 31 and a dynamic component 58, namely rotating component, mounted on the radially inner ring 20.

The static component 70 of the sealing device 50 comprises:

a shaped metallic support 51 which is mounted against the radially outer ring 31 and also inside an aperture 82, which is defined by the flange 21 and by the radially outer ring 31 and which generally constitutes a main entry point for any contaminants such as mud, dust and suspended and/or dissolved particulate matter which, if they penetrate inside the bearing unit 30, could negatively affect correct operation thereof;

first and second deflector lips 53a and 53b made of elastomeric material and co-moulded on the shaped metallic support 51, the lip 53a being substantially on the outside of the aperture 82 for initially deflecting the contaminant towards the outside of the sealing device 50, while the lip 53b extends substantially over the entire aperture 82 as far as the flange 21, without coming into contact with it; and

a pair of contacting lips 56, 57, which are again made of elastomeric material and which make contact with the dynamic component 58, the lip 56 being radially on the outside of the lip 57 so as to define with the dynamic component 58 an internal volume 59.

The dynamic component 58 is defined by a shaped metallic screen 58 which is mounted axially against the flange 21 and comprises two cylindrical tubular portions 81a and 81b extending from the flange 21 towards the radially outer ring 31, the cylindrical tubular portion 81a thereof being keyed onto the radially inner ring 20 so that the shaped metallic screen 58 is angularly integral with the radially inner ring 20, while the cylindrical tubular portion 81b extends so as to cover axially the aperture 82 and define, together with the contacting lip 56, the internal volume 59.

The entry of contaminants inside the internal volume 59 is limited by the presence of a labyrinth seal 60 defined essentially by the second deflector lip 53b and by the metallic screen 58. However, both during operational working conditions and during the validation tests carried out on the bearing unit 30, it may happen that the labyrinth seal 60 as described above is unable, in particular in particularly critical working conditions, to prevent entirely such contaminants from being able in any case to enter inside the volume 59 and, therefore, with a solution such as that described hitherto, it becomes difficult to keep the labyrinth seal 60 impermeable and the volume 59 empty, with the risk of negatively affecting the performance of the bearing unit 30.

For the purpose, therefore, of improving the sealing capacity of the sealing device 50, the dynamic component 58 further comprises a fixed spoiler 54 which represents, in combination with that described above, the novel element according to the present invention, in a preferred embodiment, and is arranged at one end of the cylindrical tubular portion 81b along the labyrinth seal 60 between the second deflector lip 53b and the volume 59. The spoiler 54 is fixed and integral with the cylindrical tubular portion 81b from which it extends radially outwards and is rotatable about the axis X together with the metallic screen 58 so as to create turbulent motion inside the labyrinth seal 60 should there be any contaminant inside the labyrinth seal 60 itself, thereby preventing it from entering inside the internal volume 59.

The spoiler 54 has a radial length which is at least one and a half times the dimension of a thickness of the cylindrical tubular portion 81b and defines inside the labyrinth seal 60:

a first labyrinth portion 60a in an axial direction between the cylindrical tubular portion 81b and the second deflector lip 53b,

a second labyrinth portion 60b in a radial direction arranged between the spoiler 54 and the shaped metallic support 51, and

an annular connecting window 60c in an axial direction arranged between a free end of the spoiler 54 and the second deflector lip 53b so as to connect together the first labyrinth portion 60a and the second labyrinth portion 60b.

The first labyrinth portion 60a has an axial length L1 such as to not only cause a rapid reduction in a speed of the contaminant along the first labyrinth portion 60a towards the window 60c, but also favour the turbulent motion which pushes, on the contrary, the contaminant towards the outside of the labyrinth 60 also facilitated by a slight conicity of the second deflector lip 53b, the conicity opening out towards the flange 21. The second labyrinth portion 60b has, instead, an axial width L2 which is preferably as small as possible depending on the specifications of the sealing device 50 and, in any case, not greater than a radial width L3 of the window 60c, which in any case represents the narrowest point of the labyrinth seal 60.

The spoiler 54 is obtained by folding over, radially outwards, a free end of the cylindrical tubular portion 81b and represents a technical solution which is undoubtedly low-cost, in particular when compared with the use of any contacting or non-contacting lips in addition to those already present and described above. The simple and low-cost production of the spoiler 54 is not the only advantage of this solution since the use of the spoiler 54 also allows shaping of the labyrinth seal 60 depending on the type of application.

To summarize, this solution, defined in the best way depending on the motor vehicle application, guarantees a greater efficiency owing to the improved sealing performance in the field, avoiding corrosion problems due to the possible entry of contaminants and does not result in any increase in the friction torque of the sealing device 50, thereby improving the performance of the bearing unit 30.

In addition to the embodiments of the invention, as described above, it is understood that there exist numerous further variants. It must also be understood that the embodiments are provided only by way of example and do not limit the subject of the invention, nor its applications, nor its possible configurations. On the contrary, although on the basis of the above description the person skilled in the art is able to implement the present invention at least according to one example of configuration thereof, it must be understood that numerous variations of the components described are feasible, without thereby departing from the scope of the invention, as defined in the attached claims, interpreted literally and/or in accordance with their legal equivalents.

1. A sealing device for a bearing unit (30), the sealing device comprising:
a dynamic component,
a static component comprising a shaped metallic support, and a plurality of sealing lips not making contact with the dynamic component and two lips making contact with the dynamic component, wherein a second sealing lip of the non-contacting sealing lips and the dynamic component define a labyrinth seal, and
a fixed spoiler arranged along the labyrinth seal for the creation of turbulent motion inside the labyrinth seal to provide a complete sealing action preventing any entry of components inside the bearing unit.

2. The sealing device according to claim 1, wherein the fixed spoiler defines inside the labyrinth seal a first labyrinth portion in an axial direction, a second labyrinth portion in a radial direction, and an annular connecting window in an axial direction for connecting together the first labyrinth portion and the second labyrinth portion; the window forming the narrowest point of the labyrinth seal.

3. The sealing device according to claim 2, wherein the dynamic component is defined by a shaped metallic screen and comprises two cylindrical tubular portions extending towards the static component; the spoiler being integrally fixed with a first cylindrical tubular portion of the two cylindrical tubular portions, and extending radially outwards to rotate about an axis (X) of the bearing unit.

4. A bearing unit comprising:
a sealing device having a dynamic component, a static component comprising a shaped metallic support, and a plurality of sealing lips not making contact with the dynamic component and two lips making contact with the dynamic component, wherein a second sealing lip of the non-contacting sealing lips and the dynamic component define a labyrinth seal, and a fixed spoiler arranged along the labyrinth seal for the creation of turbulent motion inside the labyrinth seal to provide a complete sealing action preventing any entry of components inside the bearing unit.

5. A wheel hub assembly for motor vehicles, comprising:
a hub, and
a bearing unit having a sealing device having a dynamic component, a static component comprising a shaped metallic support, and a plurality of sealing lips not making contact with the dynamic component and two lips making contact with the dynamic component, wherein a second sealing lip of the non-contacting sealing lips and the dynamic component define a labyrinth seal, and a fixed spoiler arranged along the labyrinth seal for the creation of turbulent motion inside the labyrinth seal to provide a complete sealing action preventing any entry of components inside the bearing unit
